(19) United States
(12) Patent Application Publication
(10) Pub. No.: US 2025/0257775 A1
(43) Pub. Date: Aug. 14, 2025

(54) Friction Lining for Drum Brakes

(71) Applicant: TMD Friction Services GmbH, Leverkusen (DE)

(72) Inventors: Michael REESE, Kürten (DE); Olav BORGMEIER, Hückeswagen (DE)

(73) Assignee: TMD Friction Services GmbH, Leverkusen (DE)

(21) Appl. No.: 19/038,792

(22) Filed: Jan. 28, 2025

(30) Foreign Application Priority Data
Feb. 14, 2024 (DE) 102024104119.6

(51) Int. Cl. F16D 69/02; F16D 69/00; F16D 69/04

(52) U.S. Cl. CPC F16D 69/028; F16D 69/025; F16D 2069/002; F16D 2069/0483; F16D 2200/0021; F16D 2200/0065

(57) ABSTRACT

The invention relates to a friction lining mixture for the production of a brake pad for drum brakes comprising
at least 15% by weight of metal fibres, preferably steel fibres, in particular steel wool,
at least 7% by weight of glass fibres, in the form of glass fibre bundles,
at least 4% by weight resin and
at least 2% by weight of friction particles, preferably with a Mohs hardness equal to or greater than 9, and a friction lining and drum brake lining produced therefrom, and a process for producing a drum brake lining

The present invention relates to friction lining mixtures and friction linings produced therefrom, which are particularly suitable for use in drum brakes. The invention further comprises a method of manufacturing such friction linings and their use.

A drum brake is a closed and cylindrical construction. The most important components of a drum brake are the cylindrical brake drum, the brake shoes and the wheel cylinder. The wheel cylinder is pressed against the fixed brake shoes during the braking application and presses the brake shoes against the brake drum, slowing it down.

The brake shoes primarily serve as a carrier for the friction material or as a carrier for the friction lining(s). Due to the cylindrical shape of the brake drum, against which the brake shoes (lining carrier plate with friction lining) are pressed from the inside, both the lining carrier plate and, in particular, the friction lining must have a shape that is as close as possible to the inner wall of the brake drum, i.e. that takes on its shape. Friction linings or friction materials for drum brakes therefore have the necessary flowability to take on the required crescent shape in the moulding process (when the friction material/friction lining mixture is pressed).

Although the frictional properties of drum brake linings often lag behind those of disc brake pads, drum brakes also offer some advantages over disc brakes, such as an encapsulated brake that is protected against soiling and releases less brake dust into the environment and has a desired long service life.

A wide variety of friction linings are used in disc and/or drum brake linings for cars and trucks and as clutch linings.

DE-OS 2 023 227 describes the use of glass fibres in brake shoe linings with a curved braking surface.

DE 10 2021 204 132 A1 relates to a drum brake for a motor vehicle in which the brake pads contain steel wool.

The subject of EP 0 050 377 B1 is an asbestos-free friction material comprising aramid fibres, steel fibres and mineral fibres. In addition to various other materials, glass fibres can also be used as mineral fibres. The elasticity of the resulting friction linings can be adjusted by varying the binders used.

EP 2 270 353 A2 discloses friction lining mixtures for a friction lining for brake and clutch linings, which can contain a large number of components, including resin, steel wool, a small proportion of glass fibres and also friction particles in small quantities, and to which metallic tin is added to increase the performance. Applications include brake and clutch linings.

The above documents represent only a small part of the state of the art in the field of friction lining compounds and friction linings for disc and drum brake linings and for clutch linings.

Basically, it can be said that friction linings for disc and drum brakes have different compositions. Both types contain steel wool or steel fibres and/or metal fibres, such as copper or zinc fibres, for reinforcement (increasing the internal strength of a friction lining).

Disc brake friction linings (also known as disc brake pads) usually contain between 20 and 30% by weight of steel fibres for reinforcement and not significantly more than approx. 5% by weight of resin. As a rule, no glass fibre bundles are used as friction lining components in series-produced disc brake pads.

The friction linings of drum brake linings often contain 5-10% by weight of glass fibre bundles for reinforcement and significantly more resin (approx. 10-15% by weight). There are also brake pads for drum brakes in which the friction lining contains steel wool to improve the friction properties. In these cases, however, these friction linings also contain flake graphite and/or a layered silicate (e.g. vermiculite) and an increased amount of resin to ensure the flowability of the friction lining compound so that the friction lining formed takes on the crescent shape required for drum brake linings.

The flowability of a friction material can basically be influenced by different types of binder resin, a varying content of binder resin and also by solids that are smooth and have good sliding properties. These include, for example, glass fibre bundles, phyllosilicates and flake graphite. However, the use of phyllosilicates and flake graphites, for example, can lead to production difficulties and long pressing times.

Against this background, the present invention was based on the task of providing a friction material/friction lining for a drum brake (or a brake pad consisting of a lining carrier plate and friction lining) which has the best possible improved friction properties (e.g. friction coefficients) and at the same time sufficient to improved flowability, so that the friction lining formed assumes the required crescent shape stably and without cracks and thus also lies tightly against the brake drum over its entire surface. In order to ensure the simplest possible production of such a drum brake lining, the friction lining should preferably be able to be pressed directly onto the lining carrier plate without adhesive and without an underlayer. The friction lining is preferably bonded to the lining carrier plate by the friction materials themselves.

This task is solved with its various partial aspects by the friction lining mixtures according to claim 1 and friction linings for drum brakes produced therefrom. Preferred embodiments of the invention are given in the sub-claims.

The present invention thus relates to friction lining mixtures which are characterised by a special combination of metal fibres, glass fibre bundles, resin and friction particles.

The friction lining mixtures preferably comprise at least 15% by weight of metal fibres, in particular steel fibres, and these preferably in the form of steel wool, at least 7% by weight of glass fibres, which are added to the friction lining mixture in the form of glass fibre bundles, at least 4% by weight of binder resin and at least 2% by weight of friction particles.

Friction lining mixtures comprising the following components are particularly favoured:
Metal fibres, preferably steel fibres, especially steel wool 15-20% by weight,
Glass fibres, in the form of glass fibre bundles 7-10% by weight,
Binding resin 4-9% by weight and
Friction grains 2-10% by weight.

Further preferred embodiments according to the invention relate to friction lining mixtures which, in addition to the above-mentioned components, contain heavy metal sulfides from the fourth or fifth main group of the periodic table, such as sulfides of tin, antimony and bismuth, in quantities of greater than or equal to 2% by weight.

Furthermore, the friction lining mixtures according to the invention are preferably essentially free of phyllosilicates (layered silicates) and flake graphite, or contain less than 2% by weight of such materials.

The percentages by weight used in this application refer to the weight of the finished friction lining mixture.

The abrasive grains used according to the invention are preferably those with a Mohs hardness of greater than or equal to 9. Examples include SiC (Mohs hardness 9.5-9.75), Al₂O₃ (Mohs hardness 9), B₄C (Mohs hardness 9.3) and the various modifications of Si₃N₄ with a Mohs hardness of 9. These particles are preferably used in particle sizes with a diameter d50 of 3-150 μm. The particle sizes can be determined using analysers, for example those available from the French company CILAS or the German company Anton Paar GmbH.

The preferred metal fibres are steel, stainless steel, copper, brass or bronze fibres. The fibres are preferably in the form of very short fibres of 0.1 mm to 0.3 mm or medium-length fibres of 0.3 mm to 0.5 mm in length, e.g. in chip form or in the form of longer fibres or threads of more than 0.5 mm in length as wool. The metal fibres preferably have a diameter of 0.05 to 0.2 mm. Copper wool or brass shavings or filings, for example, can be used as metal fibres.

While individual glass fibres with different orientations are often used in friction linings to increase the strength or reinforcement, glass fibre bundles are used according to the invention. Here, a large number of individual short glass fibres with the same orientation are combined in bundles. In the friction lining mixture according to the invention, the glass fibre bundles increase the flowability. Preferably, fibres made of quartz glass, borosilicate glass, aluminosilicate glass, magnesium aluminosilicate glass and/or calcium aluminosilicate glass are used for this purpose. The glass fibres preferably have a length of 1 to 5 mm. The fibres have a particularly preferred length of 3 mm. The fibres preferably have a diameter of 0.5 to 50 micrometres. Glass fibre bundles, for example, are produced from a glass melt by forcing it through spinnerets made of tungsten, for example. The number of nozzles determines the bundle thickness or width. The nozzles are arranged in a row next to each other. The result is smooth platelets or tiles. The glass fibre bundles are 0.25 to 2 mm wide, for example. The bundle strand is then cut, e.g. to a length of 3 mm. Furthermore, the bundles can be provided with a sizing which, among other things, reduces the tendency to disintegrate. The sizing coating used depends on the manufacturer and consists of a coating and/or an adhesion promoter.

The resin used according to the invention can be based on natural or synthetic resin. Phenolic resins are the preferred choice. Organic synthetic resins such as resins based on cresol, alkyl, CSNL, epoxy, NBR, resorcinol, aryl, SBR and CR can also be used.

Inorganic synthetic resins, such as resins based on boron, phosphorus, silicone and chromium, can also be used.

Heavy metal sulfides can preferably be contained in the friction lining mixture in a proportion of 2 to 10% by weight. These sulfides are high-temperature lubricants and reduce hot wear. They also help to achieve a good disc cracking result. They also smooth the friction coefficients and are therefore an effective means of preventing pressure and speed fading.

The friction lining mixture can also preferably contain 15-30% by weight of coke and graphite. Cokes stabilise the performance of the friction lining. Graphite contributes to lubrication and wear reduction. Grinding graphites and/or electrode graphites can be used for this purpose.

Preferably 1-10% by weight of natural or synthetic rubber can also be contained in the friction lining mixture. This results in improved damping or noise minimisation and improved flexibility of the friction lining.

Furthermore, the friction lining mixture can preferably contain 10-40% by weight of minerals. Preferably, cost-effective fillers such as chalk, heavy spar (barite), magnesium oxide, shale powder and kaolin are used. These fillers have a friction-enhancing and wear-reducing effect.

It is particularly advantageous that the friction lining mixtures according to the invention can be pressed directly onto the lining carrier plate, thereby creating a sufficiently stable connection between the friction lining and the lining carrier plate. According to the invention, the use of an adhesive or an underlayer, which are applied to the lining carrier plate, can be dispensed with. Separate mechanical fastening aids that are connected to the lining carrier plate, such as screws, bolts or rivets, are also not necessary for a sufficiently stable connection between the friction lining and the lining carrier plate.

The friction linings produced from the friction material according to the invention have friction coefficients μ of at least 0.3, in particular from 0.4 to 0.5, with respect to dynamic friction. The friction coefficient is determined as described, for example, in Wikipedia under the keyword “friction coefficient” in the section “Calculation of frictional force”.

As explained, according to the invention, the friction material can be pressed directly onto the lining carrier plate at increased pressure and temperature without adhesive and without an underlayer, thus directly obtaining the friction lining or the brake pad/shoe for the drum brake.

In order to further increase the stability of the curved drum brake linings, the carrier plate/lining carrier plate can have one or more protrusions and/or recesses which accommodate the friction material or project into the friction material layer and which are therefore suitable for absorbing tangential forces that are transmitted via the friction lining during driving. The protrusions on the support plate, which is bent according to the curve of the brake drum, protrude into the friction material/lining to below a specified wear limit.

Preferred embodiments of carrier plates according to the invention are those in which the carrier plate has several flat recesses which are arranged in a grid-like manner on the carrier plate (on the side facing the friction lining). Furthermore, embodiments of the lining carrier plate are preferred in which the carrier plate has a plurality of elevations which are formed as pins and, in particular, embodiments in which the carrier plate has a plurality of rows of pins, the pins being arranged in a plurality of or in all of the existing planar depressions.

Another object of the present invention is a method for manufacturing the drum brake linings according to the invention, comprising a lining carrier plate with a curved surface and a friction lining arranged thereon. For this purpose, a lining carrier plate (with a surface curved according to the radius of the brake drum, as a result of which the friction lining later lies tightly against the brake drum) and a flowable friction lining mixture according to the invention are provided. Flowable friction lining mixture means that it is flowable under the manufacturing conditions of the friction linings, i.e. at the temperature and pressure used, and can be tightly arranged or bonded to the surface of the lining carrier plate and in accordance with the specified shape. Furthermore, once the mould has been filled with the friction lining mixture, no special measures are required to distribute it in the mould. After filling the mould with the friction lining mixture, the carrier plate is pressed directly onto the friction lining mixture in the mould at increased temperature and pressure. A temperature of 140-180° C. and a pressure of 30-60 N/mm2 over a period of 2-5 minutes is preferred. The friction lining is then hardened.

According to the invention, it may be provided that the friction lining thus formed is further treated after removal from the mould using conventional methods, e.g. mechanical processing (e.g. grinding).

Finally, the invention comprises the use of the friction lining mixtures according to the invention and the friction linings obtained therefrom for the production of drum brake linings.

In summary, it can be stated that the friction materials according to the invention differ both from materials used in disc brake pads and from those used in drum brake linings.

The absence of phyllosilicates (layered silicates) and flake graphites as well as a resin quantity that is unusually high for disc brake pads but rather low for drum brake linings should be mentioned as examples or differences to the state of the art. Conventional drum brake linings also do not use heavy metal sulfides or friction particles with a Mohs hardness of 9 or more. Finally, the quantitative combination of glass fibre bundles and metal fibres, in particular steel wool, according to the invention is not found in brake pads of the prior art.

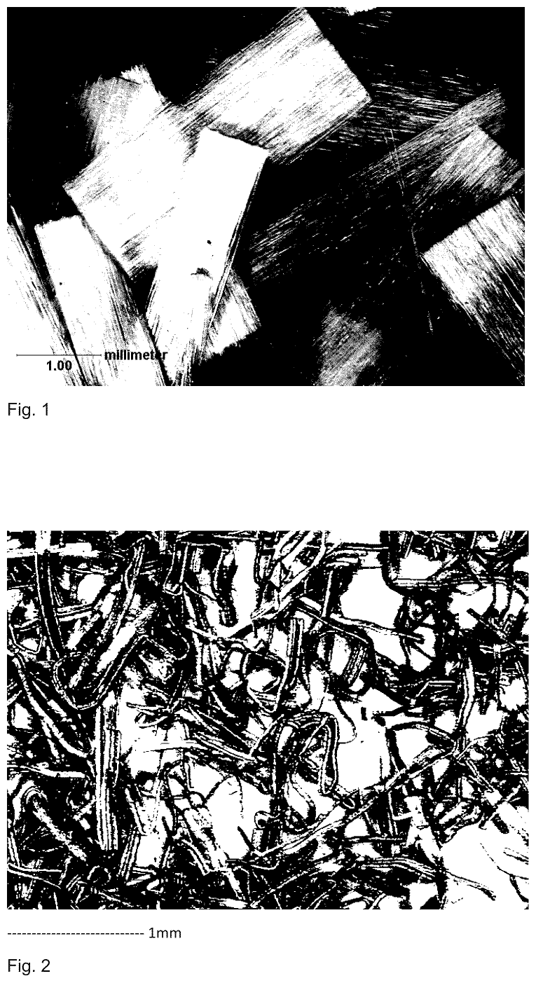

FIG. 1 shows an example of glass fibre bundles that can be used according to the invention.

FIG. 2 shows an example of metal fibres in the form of steel wool that can be used according to the invention.

1. Friction lining mixture for the manufacture of a brake pad for drum brakes comprising
at least 15% by weight of metal fibres, preferably steel fibres, in particular steel wool,
at least 7% by weight of glass fibres, in the form of glass fibre bundles,
at least 4% by weight resin and
at least 2 by weight of abrasive grains, preferably with a Mohs hardness equal to or greater than 9.

2. A friction lining mixture according to claim 1, comprising
15-20% by weight metal fibres,
7-10% by weight glass fibre bundle,
4-9% by weight resin and
2-10% by weight of abrasive grains.

3. Friction lining mixture according to claim 1 or 2, characterised in that it additionally comprises sulfides of tin, antimony and bismuth, preferably equal to or greater than 2% by weight.

4. Friction lining mixture according to one of claims 1 to 3, characterised in that the abrasive grains consist of Al₂O₃, SiC, B₄C or Si₃N₄ or mixtures thereof.

5. Friction lining mixture according to one of claims 1 to 4, characterised in that it does not comprise any layered silicates and no flake graphite.

6. Friction lining mixture according to one of claims 1 to 5, characterised in that the metal fibres are in the form of steel wool.

7. Friction lining for a drum brake, produced from a friction lining mixture according to one of claims 1 to 6.

8. Friction lining according to claim 7, characterised in that it has a friction coefficient u of at least 0.3, in particular from 0.4 to 0.5.

9. A drum brake lining comprising a lining carrier plate with a curved surface on which a friction lining according to claim 7 or 8 is arranged.

10. Drum brake lining according to claim 9, characterised in that the friction material is pressed directly onto the lining carrier plate for fastening, and in that neither adhesive nor an underlayer is arranged between the carrier plate and the friction material.

11. Drum brake lining according to claim 9 or 10, characterised in that the friction material is fastened to the lining carrier plate without separate mechanical fastening aids, and in that no screws, bolts or rivets are used.

12. Drum brake lining according to one of claims 9 to 11, characterised in that the lining carrier plate has elevations and/or depressions, the depressions being filled with friction lining and the elevations extending into the friction lining to below the wear limit.

13. Drum brake lining according to claim 12, characterised in that the indentations are flat and arranged in the form of a grid on the surface of the lining carrier plate.

14. Drum brake lining according to claim 12 or 13, characterised in that the elevations are designed as pins and are preferably arranged in several rows and, in particular, are arranged in the flat depressions.

15. A method of manufacturing a drum brake lining according to any one of claims 9 to 14, comprising the steps of
Providing a lining carrier plate with a curved surface,
Provision of a friction lining mixture,
Filling the friction lining mixture into a mould, whereby no separate measures are taken during and after the filling of the friction lining mixture to distribute the friction lining mixture in the mould,
Pressing the lining carrier plate onto the friction lining mixture in the mould at increased temperature and pressure, and
Hardening of the resulting friction lining.

16. Method according to claim 15, characterised in that no separate measures are taken to distribute the friction lining mixture in the mould during and after the filling of the friction lining composition into the mould.

17. Use of a friction lining mixture according to any one of claims 1 to 6 for the manufacture of a friction lining according to any one of claim 7 or 8.

18. Use of a friction lining according to claim 7 or 8 for the manufacture of a drum brake lining according to any one of claims 9 to 14.
